(19) United States
(12) Patent Application Publication
(10) Pub. No.: US 2026/0118124 A1
(43) Pub. Date: Apr. 30, 2026

(54) GYROSCOPE BEARING SYSTEM

(71) Applicant: Humphree AB, Göteborg (SE)

(72) Inventor: Björn HOLMENE, Sävedalen (SE)

(73) Assignee: Humphree AB, Göteborg (SE)

(21) Appl. No.: 19/369,743

(22) Filed: Oct. 27, 2025

(30) Foreign Application Priority Data
Oct. 28, 2024 (EP) 24209115.5

(51) Int. Cl. G01C 19/16; G01C 21/20

(52) U.S. Cl. CPC G01C 19/16; G01C 21/203

(57) ABSTRACT

A gyroscope bearing system for a marine gyroscope has a bearing unit having an inner ring and an outer ring and a plurality of rolling members arranged between them. The bearing unit is configured to surround and support a part of a flywheel. Ais sleeve arranged around the outer ring. A locking plate is arranged on an inner side of the gyroscope relative to the bearing unit and the sleeve. The locking plate is movable between a first position where a vertical distance is present between the sleeve, the inner ring and a top face of the locking plate, and a second position where the locking plate is abutting the sleeve and the inner ring.

### TECHNICAL FIELD

[1] The disclosure relates generally to bearing system. In particular aspects, the disclosure relates to a gyroscope bearing system. The disclosure can be applied to marine vessels, such as water crafts, motorboats, work boats, sport vessels, boats, ships, sailing boats among other vessel types. Although the disclosure may be described with respect to a particular marine vessel, the disclosure is not restricted to any particular marine vessel.

### BACKGROUND

[2] Marine gyroscopes are essential components in seafaring vessels, providing stability and reducing the rolling motion caused by ocean waves. A critical part of these gyroscopes is the bearing system, which supports the flywheel, allowing it to rotate with minimal friction. The flywheel's efficient operation is paramount to the gyroscope's effectiveness in stabilizing the vessel. However, the bearing system is subject to substantial wear and tear due to the high rotational speeds and forces exerted during operation. Regular maintenance and replacement of these bearings are necessary to ensure the gyroscope's optimal performance and longevity.

[3] In the current state of technology, the process of maintaining or replacing the bearing systems within marine gyroscopes is cumbersome and time-consuming. Typically, these systems require the entire gyroscope or significant portions of it to be dismantled, often necessitating the removal of the gyroscope from the vessel. This process not only demands skilled labor and specialized tools but also results in significant downtime for the vessel, which can be costly and inconvenient.

[4] Prior art solutions offer complex configurations that fail to provide a straightforward and efficient method for accessing and removing the bearing unit. These systems often involve intricate assemblies and require the complete disassembly of key gyroscopic components to reach the bearings, making routine maintenance a challenging task. Consequently, there is a pressing need for advancements in gyroscope bearing systems that simplify the process of bearing maintenance and replacement.

### SUMMARY

[5] According to a first aspect of the disclosure, a gyroscope bearing system for a marine gyroscope, comprising a bearing unit having an inner ring and an outer ring and a plurality of rolling members arranged between them, the bearing unit being configured to surround and support a part of a flywheel, a sleeve arranged around the outer ring, wherein a locking plate is arranged on an inner side of the gyroscope relative to the bearing unit and the sleeve, the locking plate is movable between a first position where a vertical distance is present between the sleeve, the inner ring and a top face of the locking plate, and a second position where the locking plate is abutting the sleeve and the inner ring. The first aspect of the disclosure may seek to solve the problem of cumbersome and time-consuming maintenance processes for marine gyroscopes. By providing a system that allows easier access to and replacement of the bearing unit, the invention reduces the need for extensive disassembly and minimizes vessel downtime. A technical benefit may include improved efficiency in replacing bearing units, compared to prior art configurations that require more complex disassembly. The locking plate mechanism simplifies the process of securing and releasing the bearing unit, allowing for quicker maintenance and reduced operational interruptions for marine vessels.

[6] Optionally in some examples, including in at least one preferred example, a plurality of fastening members is extending from a top part through bores in the sleeve to the locking plate. A technical benefit may include increased structural stability and ease of assembly, as the fastening members secure the components effectively, allowing for reliable operation in marine environments.

[7] Optionally in some examples, including in at least one preferred example, the fastening members have an outer thread being configured to interact with an inner thread arranged in the locking plate. A technical benefit may include enhanced ease of moving the locking plate between the first position and the second position or vice versa, and enhanced ease of disassembly and reassembly, providing a secure and adjustable connection that facilitates maintenance and reduces downtime.

[8] Optionally in some examples, including in at least one preferred example, the fastening members have a distal end in relation to the locking plate, which distal end is configured to be accessible from the outside of the system. A technical benefit may include

improved accessibility for maintenance personnel, enabling quicker adjustments and inspections.

[9] Optionally in some examples, including in at least one preferred example, the sleeve is cylindrical and the fastening members are arranged around the sleeve with a predetermined distance between them. A technical benefit may include uniform distribution of forces around the sleeve, enhancing the stability of the bearing system and reducing potential for misalignment during operation.

Optionally in some examples, including in at least one preferred example, the bearing system is configured to be moved when the locking plate is in the second position. A technical benefit may include streamlined maintenance procedures, as the system allows for easy repositioning of components without complete disassembly, thereby saving time and effort.

Optionally in some examples, including in at least one preferred example, the locking plate has an inner projection, the inner projection is configured to abut the inner ring in the second position. A technical benefit may include enhanced stability and precision in securing the bearing unit, preventing unintended movement and ensuring consistent performance during operation.

Optionally in some examples, including in at least one preferred example, the locking plate has a radial plate extension not exceeding a radial sleeve extension. A technical benefit may include a compact design that minimizes the risk of interference with other components, allowing for efficient use of space within the gyroscope assembly.

Optionally in some examples, including in at least one preferred example, the locking plate is circular. A technical benefit may include improved load distribution across the plate, contributing to a balanced and stable support structure for the bearing unit.

Optionally in some examples, including in at least one preferred example, the fastening members have a first indication indicating that the locking plate is in the first position and a second indication indicating that the locking plate is in the second position. A technical benefit may include increased safety and clarity during operation, as visual indicators help to confirm the position of the locking plate, reducing the likelihood of errors.

Optionally in some examples, including in at least one preferred example, the bearing unit has an upper bearing and a lower bearing, each bearing having an inner ring and

an outer ring. A technical benefit may include improved load distribution and redundancy, as the dual bearing configuration provides additional support and reliability for the flywheel.

According to a second aspect of the disclosure, a marine gyroscope comprising a flywheel and a gyroscope bearing system as previously disclosed. The second aspect of the disclosure may seek to solve the problem of cumbersome and time-consuming maintenance processes for marine gyroscopes. By integrating a bearing system that allows easier access to and replacement of the bearing unit, the disclosure reduces the need for extensive disassembly and minimizes vessel downtime. A technical benefit may include improved efficiency in replacing bearing units, compared to prior art configurations that require more complex disassembly.

Optionally in some examples, including in at least one preferred example, further comprising a housing sleeve, the housing sleeve is configured to house the gyroscope bearing system. A technical benefit may include additional protection and structural support, safeguarding the bearing system from environmental factors and mechanical stresses.

According to a third aspect of the disclosure, a marine vessel comprising the marine gyroscope as previously disclosed. The third aspect of the disclosure may seek to solve the problem of cumbersome and time-consuming maintenance processes for marine gyroscopes on vessels. By incorporating a gyroscope with an easily maintainable bearing system, the disclosure reduces operational disruptions and enhances the reliability of vessel stability mechanisms. A technical benefit may include improved efficiency in replacing bearing units, compared to prior art configurations that require more complex disassembly.

According to a fourth aspect of the disclosure, a method for removing a gyroscope bearing system as previously disclosed from a marine gyroscope, comprising moving the locking plate from the first position to the second position so that the locking plate is abutting the sleeve and the inner ring, removing the bearing unit, the sleeve and the locking plate from the gyroscope. The fourth aspect of the disclosure may seek to solve the problem of cumbersome and time-consuming maintenance processes for marine gyroscopes. By providing a straightforward method for accessing and removing the bearing unit, the disclosure simplifies maintenance procedures and reduces vessel downtime. A technical benefit may include improved efficiency in replacing bearing units, compared to prior art configurations that require more complex disassembly.

Optionally in some examples, including in at least one preferred example, the locking plate is moved by turning one or more fastening members. A technical benefit may include ease of operation and precision, as the use of fastening members allows for controlled and accurate adjustments to the locking plate position.

Optionally in some examples, including in at least one preferred example, the removal of the bearing unit, sleeve, and locking plate is facilitated by utilizing a jacking tool to lift the assembly from the gyroscope. A technical benefit may include reduced manual effort and increased safety, as the jacking tool provides mechanical assistance in lifting heavy components, minimizing the risk of injury or damage.

Optionally in some examples, including in at least one preferred example, further comprising applying a lubricant to the rolling members of the bearing unit after the removal to ensure smooth operation upon reinstallation. A technical benefit may include prolonged operational lifespan and reduced friction, as proper lubrication ensures optimal performance and reduces wear on rolling members.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary gyroscope bearing system according to an example shown in a cross-sectional view.

FIG. 2 is an enlarged view of the locking plate in the first position shown in a cross-sectional view.

FIG. 3 shows the gyroscope bearing system of FIG. 1 shown in a cross-sectional view.

FIG. 4 is an enlarged view of the locking plate in the second position shown in a cross-sectional view.

FIGS. 5-6 show an exemplary marine gyroscope in a cross-sectional view.

FIG. 7 shows a top view of the top part.

FIG. 8 shows a marine vessel.

### DETAILED DESCRIPTION

The detailed description set forth below provides information and examples of the disclosed technology with sufficient detail to enable those skilled in the art to practice the disclosure.

Marine gyroscopes play a crucial role in stabilizing seafaring vessels by counteracting the rolling motion caused by ocean waves. Central to their function is the bearing system, which supports the flywheel and allows it to rotate with minimal friction, thereby ensuring the gyroscope's effectiveness. However, due to the high rotational speeds and forces involved, these bearings undergo significant wear and tear, necessitating regular maintenance and replacement to maintain optimal performance and longevity. Current technology for maintaining or replacing these bearing systems is cumbersome and time-consuming, often requiring extensive disassembly of the gyroscope or its removal from the vessel. This process demands skilled labor, specialized tools, and leads to significant vessel downtime, which is costly and inconvenient. Existing solutions are complex, involving intricate assemblies that do not offer a straightforward method for accessing and removing the bearings, making routine maintenance a challenging task.

The industry demands innovative solutions that reduce the complexity of accessing and replacing the bearings within marine gyroscopes. An improved bearing system would enhance the maintainability of the gyroscope, minimize vessel downtime, and reduce maintenance costs. Such advancements are vital for the continued reliance on gyroscopic stabilization technology in marine environments, where operational efficiency and reliability are paramount.

The present disclosure addresses these issues by providing a more accessible and efficient gyroscope bearing system. It simplifies the process of maintenance and replacement, reducing the need for extensive disassembly and minimizing vessel downtime. Compared to prior solutions, this disclosure offers a practical approach that enhances operational efficiency and reliability, ultimately lowering maintenance costs and improving vessel stability.

The gyroscope is a device designed to maintain orientation and stability in a moving vessel, such as a ship, by leveraging the principles of angular momentum. At the heart of a marine gyroscope is the flywheel, a rotating mass that stabilizes the vessel by

resisting changes to its orientation. This resistance is due to the conservation of angular momentum, a fundamental principle of physics. The flywheel is supported by a bearing unit, which is critical to its function. The bearing unit comprises an inner ring, an outer ring, and a plurality of rolling members, often balls or rollers, arranged between these rings. The bearing unit is configured to support the flywheel's shaft, allowing it to rotate with minimal friction. This rotation is essential for the gyroscopic effect that stabilizes the vessel.

The bearing unit in a gyroscope serves several functions. Primarily, it ensures smooth and efficient rotation of the flywheel by reducing friction between its moving parts. This efficiency is crucial for maintaining the high rotational speeds necessary for effective stabilization. Additionally, the bearing unit aligns the flywheel's axis, ensuring it rotates precisely and consistently.

Throughout operation, the bearing unit withstands various forces. Radial forces act perpendicular to the flywheel's shaft, primarily due to the flywheel's weight and the centrifugal forces generated by its rotation. These forces are significant, especially at high rotational speeds. Axial forces, although typically less than radial forces, also exert pressure parallel to the shaft, often resulting from misalignments or external impacts. The bearing unit must be robust enough to handle these forces without compromising the flywheel's rotation or the overall stability of the gyroscope.

Hence, the bearing unit in a marine gyroscope is pivotal for supporting the flywheel, allowing it to rotate smoothly and withstand the various radial and axial forces encountered during operation. This ensures the gyroscope can effectively stabilize the vessel, maintaining its orientation amidst the dynamic conditions at sea.

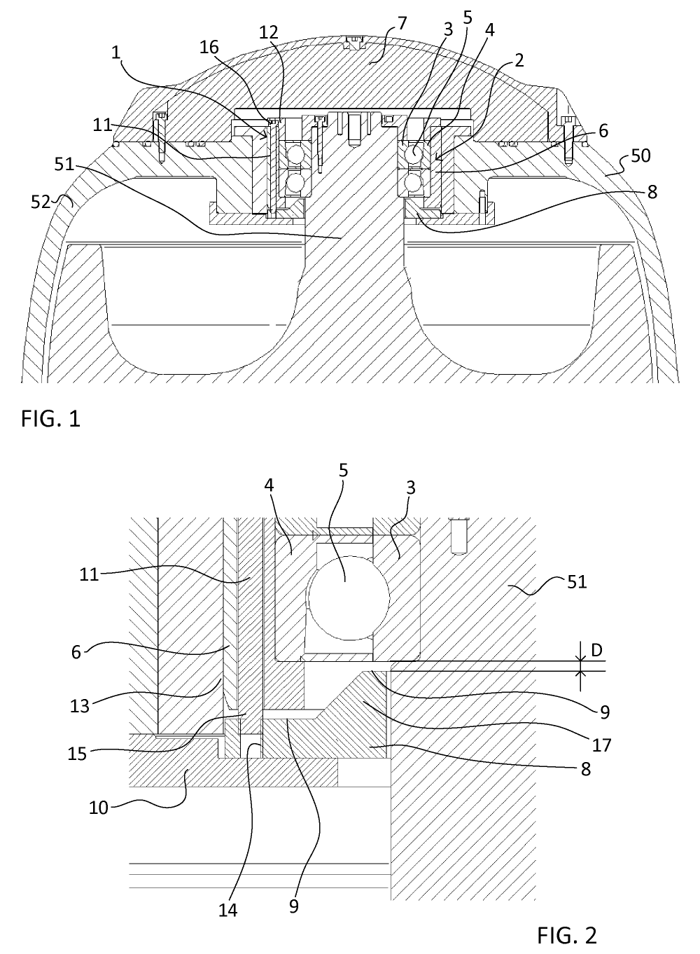

FIGS. 1-4 are an exemplary gyroscope bearing system 1 according to an example. The gyroscope bearing system 1 is arranged in a marine gyroscope 50. In FIG. 1, only the upper part of the gyroscope 50 is shown in a cross-section. The gyroscope bearing system 1 comprises a bearing unit 2 having an inner ring 3 and an outer ring 4 and a plurality of rolling members 5 arranged between them, the bearing unit 2 being configured to surround and support a part of a flywheel 51. In addition, a sleeve 6 arranged around the outer ring 4. According to the disclosure, a locking plate 8 is arranged on an inner side of the gyroscope 50 relative to the bearing unit 2 and the sleeve 6, the locking plate 8 is movable between a first position where a vertical distance is present between the sleeve 6, the inner ring 3 and a top face 9 of the locking plate 8, and a second position where the locking plate 8 is abutting the

sleeve 6 and the inner ring 3. In FIG. 1, the locking plate 8 is arranged below the bearing unit 2. Furthermore, the locking plate 8 may be arranged proximal the flywheel 51.

In FIGS. 1-2, the locking plate 8 is shown in the first position. In the first position the gyroscope bearing system 1 is in the operation mode where the bearing unit 2 supports the flywheel 51 during the normal operation of the marine gyroscope 50. FIG. 2 is an enlarged cross-sectional view of the locking plate 8 in relation to the other parts of the bearing system 1. In the first position, a vertical distance D is present between the sleeve 6, the inner ring 3 and a top face 9 of the locking plate 8 . A flange 10 is arranged below the locking plate 8 to ensure that the locking plate 8 cannot be moved below the first position.

A plurality of fastening members 11 are extending from a top part 12 through bores in the sleeve 6 into the locking plate 8. The fastening members 11 ensure that the locking plate 8 is maintained in the intended position and that the locking plate 8 may be moved. The fastening members have an outer thread 15 being configured to interact with an inner thread 14 arranged in the locking plate 8. A technical benefit may include enhanced ease of disassembly and reassembly, providing a secure and adjustable connection that facilitates maintenance and reduces downtime. The fastening members 11 have a distal end 16 in relation to the locking plate 8, which distal end 16 is configured to be accessible from the outside of the system. A technical benefit may include improved accessibility for maintenance personnel, enabling quicker adjustments and inspections without removing the entire cover.

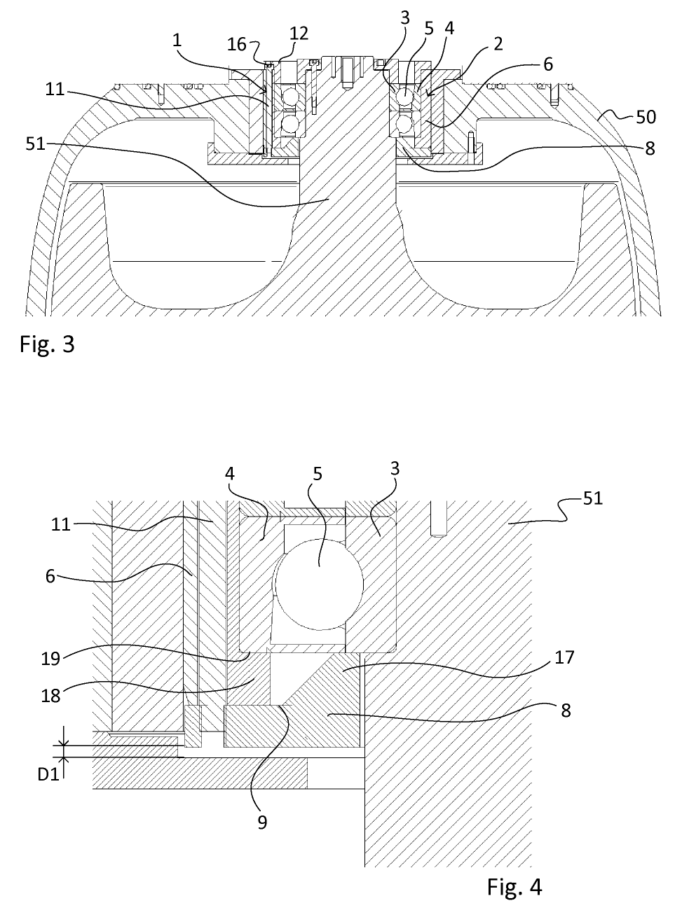

Furthermore, the locking plate 8 may have an inner projection 17, the inner projection 17 is configured to abut the inner ring 3 in the second position as shown in FIGS. 3-4. A technical benefit may include enhanced stability and precision in securing the bearing unit, preventing unintended movement and ensuring consistent performance during operation.

Also, the locking plate 8 may have a radial plate extension not exceeding a radial sleeve extension. A technical benefit may include a compact design that minimizes the risk of interference with other components, allowing for efficient use of space within the gyroscope.

Moreover, the locking plate 8 is circular. The locking plate 8 may be disc-formed with an opening in the center providing space for the flywheel 51. A technical benefit may include improved load distribution across the locking plate 8, contributing to a balanced and stable support structure for the bearing unit 2.

A cover 7 is arranged above the bearing system 1 for protecting the system. The cover 7 is removable arranged to a housing 52 of the gyroscope 50.

In FIGS. 3-4, the second position of the locking plate 8 is shown where the locking plate 8 is abutting the sleeve 6 and the inner ring 3. The cover 7 has been removed so that access to the bearing system 1 is provided. An operator may then activate the fastening members 11 so that the locking plate 8 is moved by screwing the outer thread of the fastening members 11 into the inner thread of the locking plate whereby the locking plate 8 will be arranged in the second position wherein it abuts the sleeve 6 and the inner ring 3 as seen in FIG. 4. The locking plate 8 has been moved a vertical distance creating a distance D1 from the flange 10. The distance D1 is substantially equal to the vertical distance D. In the second position of the locking plate the bearing unit 2 and the sleeve 6 is connected with each other so that they may be removed from the gyroscope in an expedient manner.

Furthermore, the sleeve 6 may have a lower radial projection 18, the lower radial projection 18 has a horizontal face 19 supporting the outer ring 4. A technical benefit may include enhanced support for the bearing unit, reducing stress on the outer ring and prolonging the lifespan of the system.

Moreover, the fastening members 11 may have a first indication indicating that the locking plate 8 is in the first position and a second indication indicating that the locking plate 8 is in the second position. A technical benefit may include increased safety and clarity during operation, as visual indicators help to confirm the position of the locking plate, reducing the likelihood of errors. The indications may be position of the distal end in relation to the top part. The top part 12 may comprise a recess wherein the distal end may be moved. The recess may indicate the position of the locking plate 8, such as when the distal end is arranged a distance from a top face of the top part the locking plate 8 is in the first position, and when the distal end is aligned with the top face of the top part the locking plate 8 is in the second position.

Furthermore, three or more fastening members may extend from the top part through the sleeve into the locking plate. These fastening members are designated to ensure that the locking plate not is able to be moved further below in the intended position in the first position.

Additionally, the fastening members may be screws or bolts. A technical benefit may include ease of use and availability, as screws and bolts are common fasteners that

facilitate straightforward assembly and disassembly processes. The fastening members 11 may also have a head at the distal end facilitating screwing of the fastening members 11.

In the example disclosed in FIGS. 1-4, the bearing unit 2 has an upper bearing and a lower bearing, each bearing having an inner ring and an outer ring. A technical benefit may include improved load distribution and redundancy, as the dual bearing configuration provides additional support and reliability for the flywheel. In other examples, a different number of bearings may be incorporated in the bearing system, such as one, two, three or more.

Moreover, the rolling members may be balls, rollers, or similar parts. A technical benefit may include versatility in adapting to different operational requirements, as various rolling member types can be selected to optimize performance and reduce friction.

Also, the bearing unit may be configured with a self-lubricating mechanism to enhance the longevity of the rolling members. A technical benefit may include reduced maintenance requirements and improved reliability, as the self-lubricating mechanism ensures continuous smooth operation without frequent manual lubrication.

Additionally, the plurality of rolling members may be coated with a friction-reducing material to minimize wear. A technical benefit may include decreased friction and improved efficiency, leading to lower energy consumption and extended lifespan of the rolling members.

In an example, the locking plate may be designed with a non-conductive material to prevent electrical interference with the gyroscope's operation. A technical benefit may include increased operational safety and reliability, as the non-conductive material prevents electrical shorts and interference.

Moreover, the fastening members may include a locking feature to prevent accidental loosening during operation. A technical benefit may include increased security and stability, ensuring that the components remain firmly in place during operation, even under dynamic conditions.

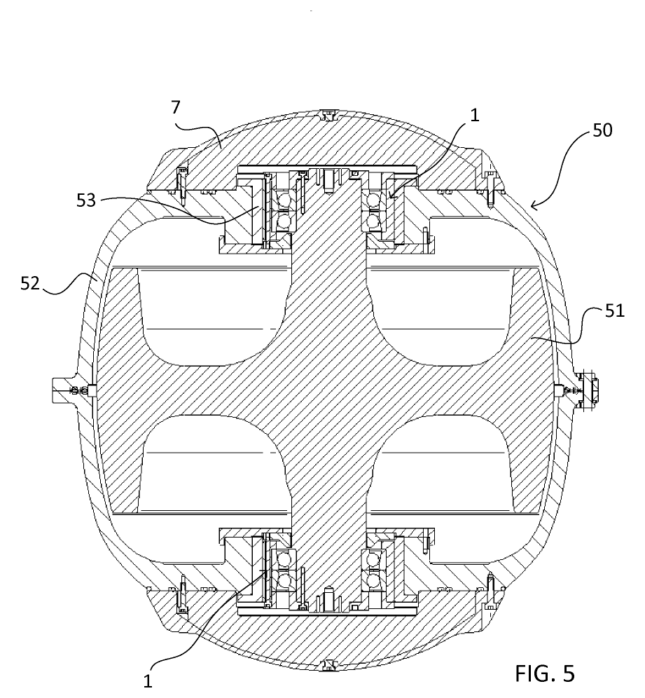

In FIG. 5, the marine gyroscope 50 is shown in a cross-sectional view. The flywheel 51 is supported by two bearings systems 1, one at the top and one of the bottom. The bearing systems 1 are substantially identically but are inverted. The gyroscope 50 further comprising a housing sleeve 53, the housing sleeve 53 is configured to house the gyroscope bearing system 1. A technical benefit may include additional protection and structural

support, safeguarding the bearing system from environmental factors and mechanical stresses. Hence, the locking plate may be arranged below the bearing unit in the top bearing system, and in the inverted bottom bearing system, the locking plate may be arranged above the bearing unit. Accordingly, the locking plate is arranged on an inner side of the gyroscope relative to the bearing unit.

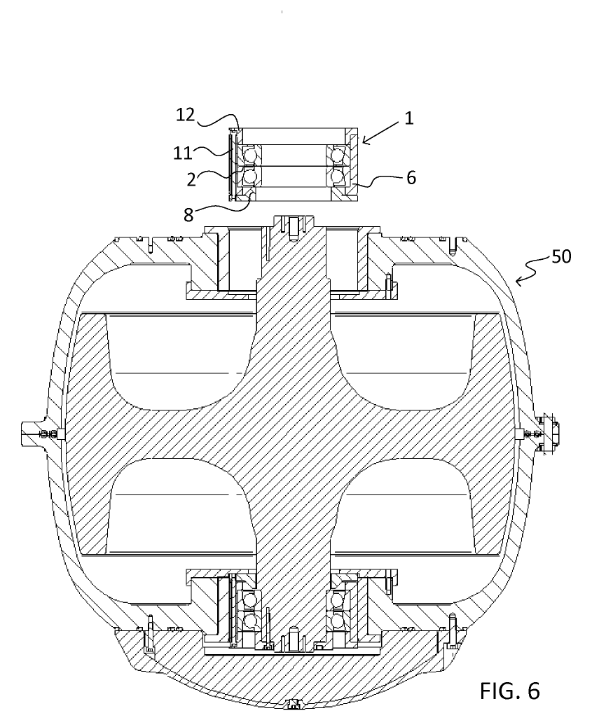

In FIG. 6, the gyroscope 50 is shown in a cross-sectional view, with the bearing system 1 removed from the gyroscope 50. The locking plate 8 together with the sleeve 6, top part 12 and the fastening members 11 ensure that the bearing unit 2 are protected so that it may be removed as a single component.

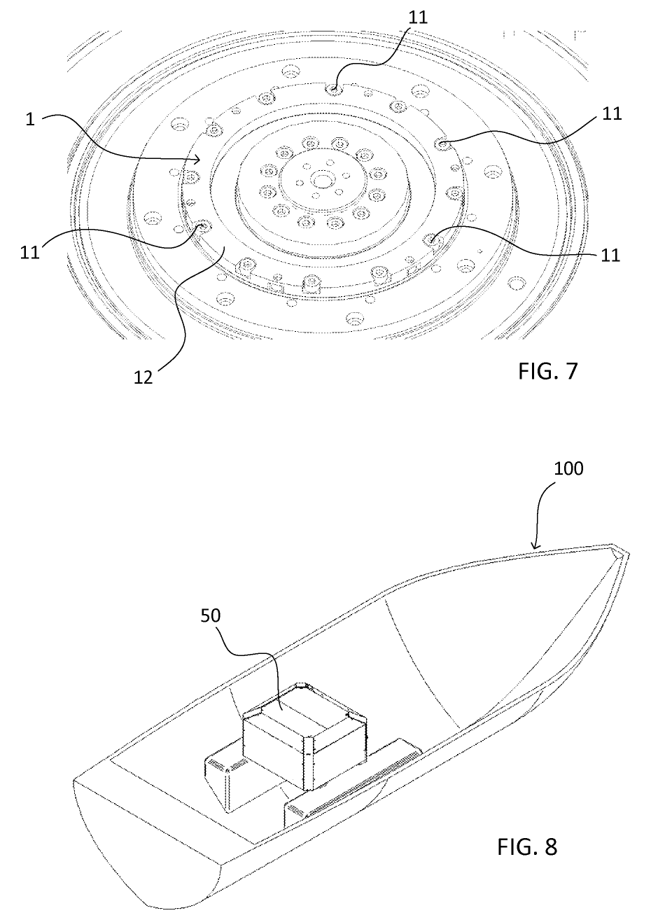

In FIG. 7, a perspective top view of the bearing system 1 is shown. The top part 12 is visible and the fastening members 11 are arranged around the top part 12 with a predetermined distance between them. The sleeve is not visible in FIG. 7, however, it is round seen in a top view. A technical benefit may include uniform distribution of forces around the sleeve, enhancing the stability of the bearing system and reducing potential for misalignment during operation.

In FIG. 8, a vessel 100 is shown. The vessel 100 comprises the marine gyroscope 50 having the bearing system according to the disclosure.

In addition, a jacking ring may be configured to be arranged above and around the gyroscope bearing system, the jacking ring has an inner diameter being larger than an outer diameter of the sleeve whereby the jacking ring is abutting a house sleeve of the gyroscope. A technical benefit may include simplified lifting and positioning of the bearing system, enabling easier adjustments and maintenance without requiring extensive disassembly. The jacking ring may have an inwardly projecting flange, the inwardly projecting flange has a plurality of bores. A technical benefit may include increased stability and secure attachment, as the flange and bores provide precise alignment and support during operation. In addition, a plurality of jacking bolts may be configured to be inserted into the bores and screwed into a plurality of corresponding threads arranged in the top part. A technical benefit may include enhanced control over the lifting and positioning process, allowing for precise adjustments and secure fastening of the jacking ring to the cover.

Furthermore, a jacking tool may be arranged in connection with the jacking ring so that the bearing unit, sleeve and the locking plate can be moved up into the jacking ring by activating the jacking tool. A technical benefit may include reduced manual effort and

increased efficiency, as the jacking tool automates the process of lifting and securing the bearing components.

The present disclosure also relates to a kit comprising a gyroscope bearing system as previously disclosed, a jacking ring and a plurality of jacking bolts. A technical benefit may include comprehensive and convenient packaging, providing all necessary components for installation and maintenance in a single kit, facilitating ease of use and procurement. The kit may further comprise a jacking tool. A technical benefit may include enhanced versatility and functionality, as the inclusion of a jacking tool allows for efficient and controlled lifting and positioning of the gyroscope bearing system components.

The present disclosure also relates to a method for removing a gyroscope bearing system 1 as disclosed from a marine gyroscope, comprising moving the locking plate 8 from the first position to the second position so that the locking plate 8 is abutting the sleeve 6 and the inner ring 3, removing the bearing unit 2, the sleeve 6 and the locking plate 8 from the gyroscope. A technical benefit may include streamlined and efficient maintenance procedures, allowing for rapid removal and replacement of components without extensive disassembly.

Furthermore, the locking plate 8 may be moved by turning one or more fastening members. A technical benefit may include ease of operation and precision, as the use of fastening members allows for controlled and accurate adjustments to the locking plate position.

Additionally, the removal of the bearing unit, sleeve, and locking plate may be facilitated by utilizing a jacking tool to lift the assembly from the gyroscope. A technical benefit may include reduced manual effort and increased safety, as the jacking tool provides mechanical assistance in lifting heavy components, minimizing the risk of injury or damage.

Moreover, the method may also comprise applying a lubricant to the rolling members of the bearing unit after the removal to ensure smooth operation upon reinstallation. A technical benefit may include prolonged operational lifespan and reduced friction, as proper lubrication ensures optimal performance and reduces wear on rolling members.

Certain aspects and variants of the disclosure are set forth in the following examples numbered consecutive below.

Example 1: A gyroscope bearing system (1) for a marine gyroscope (50), comprising a bearing unit (2) having an inner ring (3) and an outer ring (4) and a plurality of

rolling members (5) arranged between them, the bearing unit (2) being configured to surround and support a part of a flywheel (51), a sleeve (6) arranged around the outer ring (4), wherein a locking plate (8) is arranged below the bearing unit (2) and the sleeve (6), the locking plate (8) is movable between a first position where a vertical distance is present between the sleeve (6), the inner ring (3) and a top face (9) of the locking plate (8), and a second position where the locking plate (8) is abutting the sleeve (6) and the inner ring (3).

Example 1a: A gyroscope bearing system (1) for a marine gyroscope (50), comprising a bearing unit (2) having an inner ring (3) and an outer ring (4) and a plurality of rolling members (5) arranged between them, the bearing unit (2) being configured to surround and support a part of a flywheel (51), a sleeve (6) arranged around the outer ring (4), wherein a locking plate (8) is arranged on an inner side of the gyroscope relative to the bearing unit (2) and the sleeve (6), the locking plate (8) is movable between a first position where a vertical distance is present between the sleeve (6), the inner ring (3) and a top face (9) of the locking plate (8), and a second position where the locking plate (8) is abutting the sleeve (6) and the inner ring (3).

Example 2: The gyroscope bearing system (1) of any of the Examples 1-1a, wherein a plurality of fastening members (11) is extending from a top part (12) through bores in the sleeve (13) to the locking plate (8).

Example 3: The gyroscope bearing system (1) of Example 2, wherein the fastening members (11) have an outer thread (15) being configured to interact with an inner thread (14) arranged in the locking plate (8).

Example 4: The gyroscope bearing system (1) of Example 2 and/or 3, wherein the fastening members (11) have a distal end (16) in relation to the locking plate (8), which distal end (16) is configured to be accessible from the outside of the system.

Example 5: The gyroscope bearing system (1) of any of the Examples 2-4, wherein the sleeve (6) is cylindrical and the fastening members (11) are arranged around the sleeve with a predetermined distance between them.

Example 6: The gyroscope bearing system (1) of any of the Examples 1-5, wherein the bearing system is configured to be moved when the locking plate (8) is in the second position.

Example 7: The gyroscope bearing system (1) of any of the Examples 1-6, wherein the locking plate (8) has an inner projection (17), the inner projection (17) is configured to abut the inner ring (3) in the second position.

Example 8: The gyroscope bearing system (1) of any of the Examples 1-7, wherein the locking plate (8) has a radial plate extension not exceeding a radial sleeve extension.

Example 9: The gyroscope bearing system (1) of any of the Examples 1-8, wherein the locking plate (8) is circular.

Example 10: The gyroscope bearing system (1) of any of the Examples 1-9, wherein the sleeve (6) has a lower radial projection (18), the lower radial projection (18) has a horizontal face supporting the outer ring (4).

Example 11: The gyroscope bearing system (1) of any of the Examples 2-10, wherein the fastening members (11) have a first indication indicating that the locking plate (8) is in the first position and a second indication indicating that the locking plate is in the second position.

Example 12: The gyroscope bearing system (1) of any of the Examples 1-11, wherein the bearing unit (2) has an upper bearing and a lower bearing, each bearing having an inner ring and an outer ring.

Example 13: The gyroscope bearing system (1) of any of the Examples 1-12, wherein the rolling members (5) are balls, rollers, or similar parts.

Example 14: The gyroscope bearing system (1) of any of the Examples 2-13, wherein the fastening members (11) are screws or bolts.

Example 15: The gyroscope bearing system (1) of any of the Examples 1-14, wherein a jacking ring is configured to be arranged above and around the gyroscope bearing system, the jacking ring has an inner diameter being larger than an outer diameter of the sleeve (6) whereby the jacking ring is abutting a house sleeve of the gyroscope.

Example 16: The gyroscope bearing system (1) of Example 15, wherein the jacking ring has an inwardly projecting flange, the inwardly projecting flange has a plurality of bores.

Example 17: The gyroscope bearing system (1) of Example 16, wherein a plurality of jacking bolts is configured to be inserted into the bores and screwed into a plurality of corresponding threads arranged in the top part (12).

Example 18: The gyroscope bearing system (1) of any of the Examples 15-17, wherein a jacking tool is arranged in connection with the jacking ring so that the bearing unit, sleeve and the locking plate can be moved up into the jacking ring by activating the jacking tool.

Example 19: The gyroscope bearing system (1) of any of the Examples 1-18, wherein the sleeve (6) comprises a cushioning layer on its inner surface to reduce vibrations transmitted to the bearing unit (2).

Example 20: The gyroscope bearing system (1) of any of the Examples 1-19, wherein the sleeve (6) includes a heat dissipation feature to manage temperature variations in the bearing unit (2).

Example 21: The gyroscope bearing system (1) of any of the Examples 1-20, wherein the bearing unit (2) is configured with a self-lubricating mechanism to enhance the longevity of the rolling members (5).

Example 22: The gyroscope bearing system (1) of any of the Examples 1-21, wherein the plurality of rolling members (5) is coated with a friction-reducing material to minimize wear.

Example 23: The gyroscope bearing system (1) of any of the Examples 1-22, wherein the locking plate (8) is designed with a non-conductive material to prevent electrical interference with the gyroscope's operation.

Example 24: The gyroscope bearing system (1) of any of the Examples 2-23, wherein the fastening members (11) include a locking feature to prevent accidental loosening during operation.

Example 25: The gyroscope bearing system (1) of any of the Examples 1-24, further comprising a cover (7) arranged above the sleeve (6).

Example 26: A kit comprising a gyroscope bearing system (1) of any of the Examples 1-25, a jacking ring and a plurality of jacking bolts.

Example 27: The kit of Example 26, further comprising a jacking tool.

Example 28: A marine gyroscope (50) comprising a flywheel (51) and a gyroscope bearing system (1) of any of the Examples 1-25.

Example 29: The marine gyroscope (50) of Example 28, further comprising a housing sleeve (53), the housing sleeve (53) is configured to house the gyroscope bearing system (1).

Example 30: A marine vessel (100) comprising the marine gyroscope (50) of any of the Examples 28-29.

Example 31: A method for removing a gyroscope bearing system (1) of any of the Examples 1-25 from a marine gyroscope (50), comprising moving the locking plate (8) from the first position to the second position so that the locking plate (8) is abutting the sleeve (6) and the inner ring (3), removing the bearing unit (2), the sleeve (6) and the locking plate (8) from the gyroscope.

Example 32: The method of Example 31, whereby the locking plate (8) is moved by turning one or more fastening members (11).

Example 33: The method of Example 31, whereby the removal of the bearing unit (2), sleeve (6), and locking plate (8) is facilitated by utilizing a jacking tool to lift the assembly from the gyroscope.

Example 34: The method of any of the Examples 31-33, further comprising applying a lubricant to the rolling members (5) of the bearing unit (2) after the removal to ensure smooth operation upon reinstallation.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above

are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A gyroscope bearing system for a marine gyroscope, comprising
a bearing unit having an inner ring and an outer ring and a plurality of rolling members arranged between them, the bearing unit being configured to surround and support a part of a flywheel,
a sleeve arranged around the outer ring,
wherein a locking plate is arranged on an inner side of the gyroscope relative to the bearing unit and the sleeve, the locking plate being movable between a first position where a vertical distance is present between the sleeve, the inner ring and a top face of the locking plate, and a second position where the locking plate is abutting the sleeve and the inner ring.

2. The gyroscope bearing system of claim 1, wherein a plurality of fastening members is extending from a top part through bores in the sleeve to the locking plate.

3. The gyroscope bearing system of claim 2, wherein the fastening members have an outer thread being configured to interact with an inner thread arranged in the locking plate.

4. The gyroscope bearing system of claim 2, wherein the fastening members have a distal end in relation to the locking plate, which distal end is configured to be accessible from the outside of the system.

5. The gyroscope bearing system of claim 2, wherein the sleeve is cylindrical and the fastening members are arranged around the sleeve with a predetermined distance between them.

6. The gyroscope bearing system of claim 1, wherein the bearing system is configured to be moved when the locking plate is in the second position.

7. The gyroscope bearing system of claim 1, wherein the locking plate has an inner projection, the inner projection is configured to abut the inner ring in the second position.

8. The gyroscope bearing system of claim 1, wherein the locking plate has a radial plate extension not exceeding a radial sleeve extension.

9. The gyroscope bearing system of claim 2, wherein the fastening members have a first indication indicating that the locking plate is in the first position and a second indication indicating that the locking plate is in the second position.

10. The gyroscope bearing system of claim 1, wherein the bearing unit has an upper bearing and a lower bearing, each bearing having an inner ring and an outer ring.

11. The gyroscope bearing system of claim 1, wherein a jacking ring is configured to be arranged above and around the gyroscope bearing system, the jacking ring has an inner diameter being larger than an outer diameter of the sleeve whereby the jacking ring is abutting a house sleeve of the gyroscope.

12. The gyroscope bearing system of claim 11 wherein the jacking ring has an inwardly projecting flange, the inwardly projecting flange has a plurality of bores.

13. The gyroscope bearing system of claim 12, wherein a plurality of jacking bolts is configured to be inserted into the bores and screwed into a plurality of corresponding threads arranged in the top part.

14. The gyroscope bearing system of claim 11, wherein a jacking tool is arranged in connection with the jacking ring so that the bearing unit, sleeve and the locking plate can be moved up into the jacking ring by activating the jacking tool.

15. The gyroscope bearing system of claim 1, further comprising a cover arranged above the sleeve.

16. A marine gyroscope comprising a flywheel and a gyroscope bearing system of claim 1.

17. The marine gyroscope of claim 16, further comprising a housing sleeve, the housing sleeve is configured to house the gyroscope bearing system.

18. A marine vessel comprising the marine gyroscope of claim 16.

19. A method for removing a gyroscope bearing system of claim 1 from a marine gyroscope, comprising
moving the locking plate from the first position to the second position so that the locking plate is abutting the sleeve and the inner ring,
removing the bearing unit, the sleeve and the locking plate from the gyroscope.

20. The method of claim 19, whereby the locking plate is moved by turning one or more fastening members.
